(19) United States
(12) Patent Application Publication
(10) Pub. No.: US 2026/0060467 A1
(43) Pub. Date: Mar. 5, 2026

(54) BEVERAGE SYSTEM AND METHOD FOR THE RAPID PRECISE EXTRACTION OF COLD BREW BEVERAGE

(71) Applicant: AstroBrew Inc., Boxford, MA (US)

(72) Inventor: Joseph D. Damigella, Boxford, MA (US)

(21) Appl. No.: 19/311,460

(22) Filed: Aug. 27, 2025

Related U.S. Application Data
(60) Provisional application No. 63/687,977, filed on Aug. 28, 2024.

(51) Int. Cl. A47J 31/00; A23F 3/18; A23F 5/26; A47J 31/06; A47J 31/32; A47J 31/36; A47J 31/46; A47J 31/52; B67D 1/08; F25D 31/00

(52) U.S. Cl. CPC A47J 31/002; A23F 3/18; A23F 5/262; A47J 31/0668; A47J 31/32; A47J 31/3676; A47J 31/461; A47J 31/469; A47J 31/52; B67D 1/0858; F25D 31/002; F25D 31/005

(57) ABSTRACT

A modular countertop beverage brewing system and method configured to rapidly extract cold brew beverages from a brewable mixture. Three independent brewing modes are integrated, two of which regulate temperature. The modes are room temperature, chilling, and heating. Brewing is achieved through a three factored approach: the combination of pressure, water jet nozzle, and a beverage recirculation loop followed by an optional chilling system, and optional heating after brewing. The system enables forced dispense, temperature control options, and programmable brew strength. Unlike conventional systems, this device achieves cold brew in minutes rather than hours, consolidating brewing, strength, and temperature functions in a single compact unit.

### CROSS-REFERENCE TO RELATED APPLICATION(S)

This application claims priority to, and the benefit of, co-pending U.S. Provisional Application No. 63/687,977, filed Aug. 28, 2024, for all subject matter common to both applications. The disclosure of said provisional application is hereby incorporated by reference in its entirety.

### FIELD OF THE INVENTION

The present invention relates generally to beverage preparation systems, and more particularly to countertop brewing appliances configured to extract cold brew beverages through recirculation, forced turbulence, and elevated pressure. The system optionally incorporates chilling and/or heating systems to enable temperature conditioning before dispensing. The invention is suitable for preparing cold brew beverages.

### BACKGROUND

Full rapid extraction of coffee grinds into a liquid beverage at low temperatures is often referred to as cold brew, or cold brew coffee. The coffee beverage is often served at low temperatures approaching that of ice water. Many methods exist to create cold brew coffee. Many methods for the chilling and heating of water exist as well. The combination of all methods into one fast-acting machine has evaded the field of consumer and commercial applications.

Traditional cold brew coffee is steeped at room temperature for many hours, between 8 and 48 hours, depending on the desired flavor profile. For this reason, low-cost coarse-ground coffee beans are generally used due to inefficiency. Research into the prediction of a measurable extraction value for cold brew is also ongoing. The mathematics behind extraction predictions for both hot brew and cold brew coffee relies on pre-measured coefficients. However, due to the imprecise and unreliable equipment available for cold brew creation, measured results are unpredictable.

The coffee bean itself is a unique food that has a complex array of flavors and a long, rich history spanning thousands of years. Innumerable flavor combinations are possible by simply varying the factors attributed to brewing. The art form of coffee brewing has undergone significant transformations over the centuries to capture a range of desirable flavors in a single sip; evolving from simple water boiling methods to more complex brewing techniques like espresso and cold brew. Each method brings out different flavor profiles, influenced by the extraction of various coffee solubles, which are affected by factors like grind size, mass ratios, time, temperature, and pressure. The values for each of these factors can be precisely changed to allow for widely varying coffee extraction profiles.

In traditional hot brewing, coffee grinds are exposed to high-temperature water (between 100° F. and 212° F.) within a short period of time, often less than 30 seconds, depending on the method. The extraction yield (EY) is the resultant strength of the coffee beverage. It is the mass ratio of dissolved grounds to water. Dissolution, or solubility, is determined by the temperature, exposure time, and pressure, aka Total Dissolved Solids (TDS). The primary basic formula, which uses the measured data value for TDS, post brewing, is:

$$EY = \frac{TDS \times BW}{MG}$$

Where:
EY: Extraction Yield (%)
TDS: Total Dissolved Solids (%)
BW: Brew Water (g)
MG: Mass of Grounds (g)

For higher pressure systems, like espresso, the formula adapts to include pressure, reflecting how pressure accelerates extraction:

$$E = κ ( T , P ) \times ( \frac{{m}_{c}}{{m}_{w}} ) \times ( 1 - {e}^{- \frac{t}{τ ( P )}} )$$

Where k(T,P) is the extraction coefficient influenced by temperature and pressure, and τ(P) reflects the time constant under pressure.
Where:
E: Brew Extraction
k(T, P): Temperature and pressure-dependent extraction coefficient
mc/mw: Ratio of coffee mass to water mass
t: Time
τ(P): Pressure-dependent time constant

Traditional hot brewing methods create a flavor profile high in acidity, which results in bitterness and can cause indigestion.

Cold brew coffee, which uses lower temperatures (32° F. to 68° F.) and extended brewing times (8 to 48 hours), requires a different approach to extraction. The formula for cold brew extraction is:

$$E = k ( T ) \times ( {m}_{c} {m}_{w} ) \times ( 1 - {e}^{- t τ ( T )} )$$

This formula emphasizes the slower extraction rate at low temperatures, with τ(T) representing the temperature-dependent time constant. Cold brew often increases the coffee-to-water ratio to compensate for reduced solubility at lower temperatures.

While cold brewing produces a brew with a flavor profile lower in acidity and with lower bitterness and less potential indigestion, the longer brewing time (8 to 48 hours) is problematic in that the cold brew has to be prepared well in advance of the time it is to be consumed.

### SUMMARY

There is a need for a cold brewing approach that has a quicker preparation time than conventional approaches. The present invention is directed toward further solutions to address this need, in addition to having other desirable characteristics.

The incorporation of pressure into cold brew systems significantly enhances extraction efficiency. By increasing the solubility of coffee compounds, pressure reduces brewing time, while still achieving high extraction yields. The expanded formula for cold brew extraction under pressure is:

$$E = k ( T , P ) \times ( {m}_{c} {m}_{w} ) \times ( 1 - {e}^{t τ ( T , P )} )$$

This formulation accounts for how pressure, in combination with low temperature, affects both the extraction coefficient and the time constant, leading to more efficient cold brew processes.

The present invention optimizes the coffee algorithm for cold brewing in favor of reducing time factor, t, with expanded factor P for pressure. The process favors a low time value for an increase in pressure, and a decrease in temperature.

The present invention provides a beverage system that accelerates cold brew extraction through the combination of three factors: active recirculation, vortex-inducing water jet flow, and controlled pressure. These three controlled methods result in a predictable coffee strength TDS value, a direct correlation of the equation for cold brew extraction, E.

Integrated optional cooling within the flow path brings the beverage to near-freezing temperatures, while an optional heating system allows immediate dispensing of a hot beverage derived from cold brew concentrate. User-programmable controls permit selection of brew strength, time, and final temperature, offering both single-serve and batch dispenses. This unified approach to brewing extraction, chilling, and heating of cold brew beverages overcomes the extended steep times and unpredictability of traditional cold brew, eliminates the need for separate temperature equipment, and represents a novel, convenient, and energy-efficient solution.

In accordance with an embodiment of the present invention, a cold brew beverage brewing system is provided. The cold brew beverage brewing system includes a storage vessel for holding a liquid; a filter basket disposed within or above the vessel for holding a water soluble brewable mixture; a nozzle arranged to introduce high-velocity water into the filter basket to induce a turbulent vortex or whirlpool; a water pump in fluid communication between the storage vessel and nozzle, configured to circulate liquid from the vessel through the brewable mixture; an air pump configured to pressurize a headspace above the liquid in the vessel; a dispense valve configured to deliver the brewed beverage from the vessel under pressure; and a microcontroller in electrical communication with the water pump and air pump configured to control the circulation of liquid and pressure in liquid vessel. The system operates to extract flavor from the brewable mixture via controlled recirculation of the liquid at a designated pressure.

This configuration is considered to be the first of three operation modes. The internal volume of the beverage storage vessel is filled with precursor liquid water. Leading from the vessel is an outlet port to a plumbing flow path of components for the recirculation of liquid water from the bottom of the vessel through pumps, valves, and then back to the top of the vessel, where the flow path returns. The returned water is forced through a high-velocity water jet nozzle into a volume of air that sits above a filter basket filled with a precursor brewable mixture, such as coffee grinds or tea. The high-velocity water jet nozzle is angled in a way that causes pooling water in the filter basket to rotate as a whirlpool effect, creating turbulence, and encasing each individual component of the brewable mixture (e.g., coffee grind or tea leaf) with liquid water equally. The volume of air is pressurized with an air pump. The pressurized air forces the returning liquid water through the brewable mixture, resulting in a liquid cold brew beverage mixing into the bulk liquid water within the vessel. Eventually, through the mechanism of the recirculation loop, all of the precursor brewable mixture has been fully extracted into the liquid water, which has turned into a cold brew beverage. The beverage recirculates through this flow path until full extraction of the brewable mixture has completed as a timed event. The recirculation loop, powered by the water pump, operates for the duration of the extraction process. The beverage exits through a beverage dispense valve into a beverage drinking cup.

In accordance with another aspect, a beverage system contains a chilling system directly thermally coupled to the beverage flow path of the recirculation loop. This configuration is considered to be the second of three operation modes. The precursor liquid cold brew within the beverage vessel can be chilled, for example, by one or more chilling systems and is continuously flowing in and out of the thermally conductive chilling system, causing the extracted cold brew to become increasingly colder in temperature down to near-freezing temperatures. After full extraction of the cold brew beverage, the chilling cycle continues until the beverage has reached a target temperature. To enable proper cold brew extraction, the appliance is equipped with an internal chilling system that ensures the beverage water is held within a tightly controlled temperature range. This temperature regulation is essential for brewing integrity, but also for achieving the flavor profile and strength for cold brew.

The chilling system is engineered to actively manage the thermal conditions of the incoming water supply before it comes into contact with the brewable mixture. Since the extraction process for cold brew occurs at low temperatures over a defined steep time for varying strength options, the chilling system plays a critical role in maintaining thermal consistency. For example, if the water is too warm, the extraction skews bitter or acidic; too cold, and you under-extract. This system ensures precision.

In this setup, the chilling system lowers the temperature of the precursor water prior to its use in brewing. As the brewable mixture (e.g., coffee grounds) remains at ambient or slightly cooler temperatures, the chilled water essentially determines the extraction temperature of the final cold brew. The chilling system may incorporate thermoelectric modules, fans, heat sinks, or heat pipes, components commonly found in compact solid-state chiller systems, to manage this process efficiently. Alternatively, in non-compact large cold brew batch systems of the same brewing configuration, the chilling system may incorporate an evaporator, a compressor, a condenser, an expansion valve, fans, heat sinks, or heat pipes, components commonly found in high-power refrigeration chiller systems.

Just as critical as cooling is the prevention of freezing. While you want the water cold enough to slow-extract oils and/or flavors from the brewable mixture over time, any approach toward freezing could obstruct flow, damage components, or negatively affect beverage quality. To address this, sensors within the chilling system monitor fluid temperature in real time. If the temperature begins to dip near freezing within a tight tolerance, the system automatically dials back or momentarily suspends cooling activity, maintaining a safe buffer to avoid ice formation, which can damage components. This responsive thermal feedback loop ensures that the brewing water remains cold but fluid, providing optimal extraction conditions for a consistent and high-quality cold brew batch after batch.

In another aspect of the present invention, in the dispense path of the beverage machine, immediately before the beverage dispense valve is a heating element that quickly raises the temperature of the beverage water, and then a hot dispense valve that opens to allow the now hot beverage to exit the system into a beverage drinking cup. This provides for cold-brewed hot beverage. This configuration is considered to be the third of three operation modes. For example, the taste profile from traditional hot coffee is dramatically different and more desirable to the broader audience of hot coffee drinkers.

In accordance with aspects of the present invention, the filter basket is removable and constructed of stainless steel mesh, plastic, or bonded paper.

In accordance with aspects of the present invention, the system further includes a user interface button for brew strength, temperature setting, and dispense volume control.

In accordance with aspects of the present invention, the brewable mixture comprises coffee grounds. In other aspects, the brewable mixture comprises tea leaves.

In accordance with aspects of the present invention, the brewable mixture comprises a pre-measured pod or sachet of brewable mixture.

In accordance with aspects of the present invention, the designated pressure is between 2 psi and 130 psi.

In accordance with embodiments of the present invention, a method of brewing a cold brew beverage is provided. The method involves providing a cold brew beverage brewing system as describe above; filing the the beverage storage vessel with precursor liquid; filling the filter basket with a brewable mixture; sealing the storage vessel forming a closed environment within the beverage storage vessel; and initiating a microprocessor controlled brewing sequence. The brewing sequence involves powering on the water pump to begin fluid movement from the beverage storage vessel, through the water pump, and up through the water jet nozzle inducing a turbulent whirlpool or vortex in the vessel wherein beverage flow is through the brewable mixture and filter basket and back into the beverage storage vessel; activating the air pump to create a headspace of pressurized air at a desired pressure; entering a controlled recirculation loop until a desired cold brew beverage is achieved; turning off the water pump; and dispensing the desired cold brewed beverage from the dispense valve.

In accordance with aspects of the present invention, the method further involves receiving an indication of a desired cold-brew beverage via a user interface button. In some such aspects, the interface button allows for the selection of: brew strength, temperature setting, and dispense volume.

In accordance with aspects of the present invention, the method further involves chilling the desired cold-brewed beverage using a chilling system in thermal contact with a recirculated liquid flow.

In accordance with aspects of the present invention, the method further involves heating the desired cold-brew beverage using a heating system in thermal contact with a dispensing beverage flow. In some such aspects, the method further involves dispensing a heated cold-brewed beverage from a dedicated dispense valve downstream of the heating system.

In accordance with aspects of the present invention, the desired pressure is between 2 psi and 130 psi.

In accordance with aspects of the present invention, the filter basket is removable and constructed of stainless steel mesh, plastic, or bonded paper.

In accordance with aspects of the present invention, the nozzle is configured to introduce liquid at an angle to induce whirlpool flow.

In accordance with aspects of the present invention, the brewable mixture comprises coffee grounds.

In accordance with aspects of the present invention, the brewable mixture comprises tea leaves.

### BRIEF DESCRIPTION OF THE FIGURES

These and other characteristics of the present invention will be more fully understood by reference to the following detailed description in conjunction with the attached drawings, in which:

FIG. 1 illustrates a beverage machine for brewing cold brew beverages, and chilling or heating;

FIG. 2 illustrates a side view of the beverage machine for brewing cold brew beverages, and chilling or heating;

FIG. 3 illustrates a side cutaway explosion view of the internal components of the beverage machine for brewing cold brew beverages, and cooling or heating;

FIG. 4 illustrates an exploded view of the internal components of the beverage machine for brewing cold brew beverages, and cooling or heating;

FIG. 5 illustrates the position of the water jet nozzle, the issuing water jet, and resulting turbulent vortex or whirlpool in the beverage vessel of the beverage machine;

FIG. 6 illustrates an isotropic explosion view of the internal components of the beverage machine;

FIG. 7 illustrates an operating schematic for mode one of a beverage machine for brewing cold brew beverages;

FIG. 8 illustrates the plumbing schematic for one embodiment of a beverage machine for brewing cold brew beverages;

FIG. 9 illustrates a plumbing schematic for a second embodiment of a beverage machine for brewing and chilling cold brew beverages; and

FIG. 10 illustrates a plumbing schematic for a third embodiment of a beverage machine for brewing, and chilling or heating of cold brew beverages.

### DETAILED DESCRIPTION

An illustrative embodiment of the present invention relates to a compact beverage brewing appliance capable of rapidly preparing cold brew beverages via a three-factor method that comprises a water jet nozzle, controlled recirculation by a water pump, and a pressurized beverage path by an air pump. The system integrates three modes of temperature operation: mode one is for ambient brewing, mode two is for chilling, and mode three is for chilling and heating, thereby providing modular flexibility across multiple brew configurations.

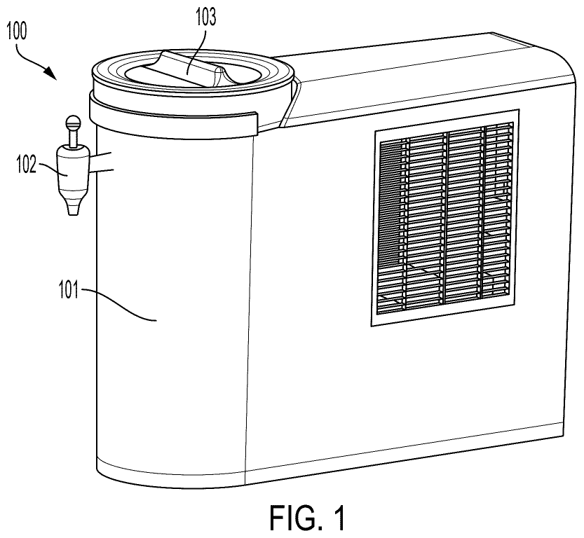

FIG. 1 through FIG. 10, wherein like parts are designated by like reference numerals throughout, illustrate an example embodiment or embodiments of a cold brew beverage brewing system, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

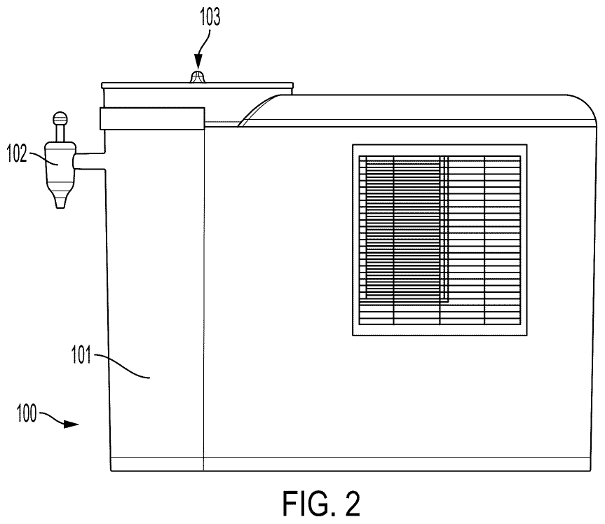

FIG. 1 and FIG. 2 show the cold brew beverage system (100) from an isotropic view and a side view, which includes a beverage storage vessel (101), dispense valve (102) for delivering the cold brewed beverage, and a pressure seal (103). The entire system is housed in an insulated, compact enclosure suitable for countertop use. These components work together to extract flavor from coffee grounds efficiently while optionally chilling or heating the beverage.

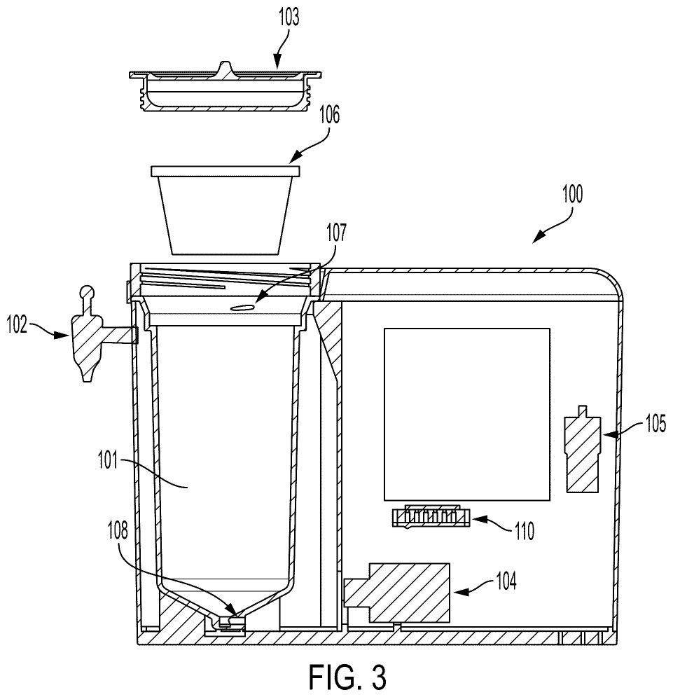

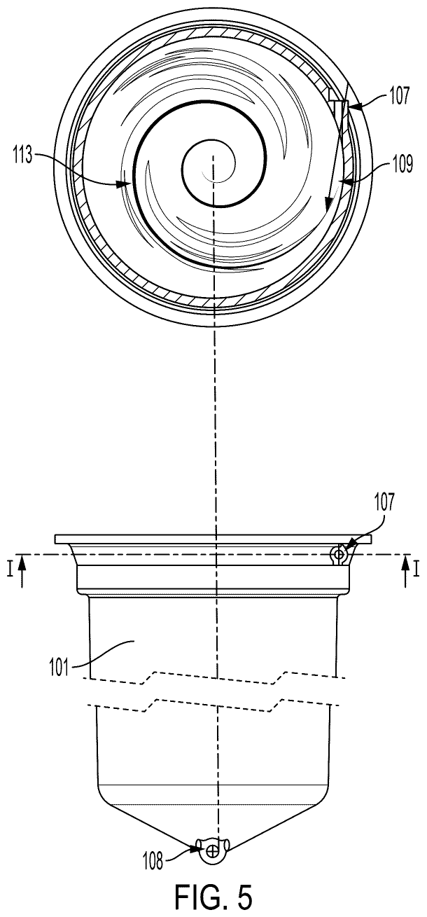

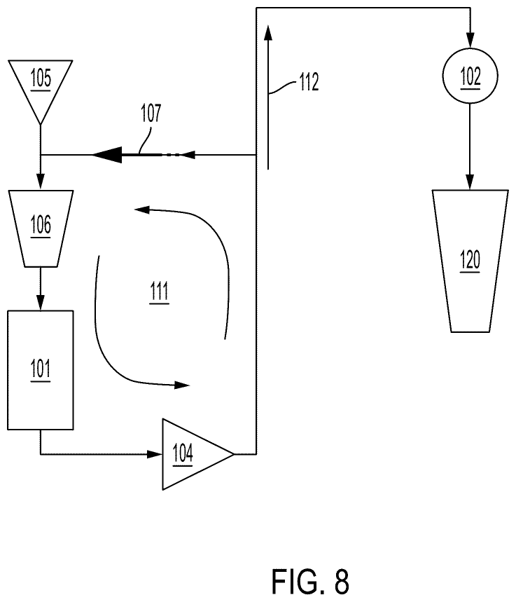

FIG. 3 shows an exploded internal component view from the side perspective. The side cutaway explosion view in FIG. 3 highlights structural arrangement of the beverage vessel (101), pressure seal (103), filter basket (106) disposed within or above the vessel (101) for holding a water soluble brewable mixture (114), water jet nozzle (107) for introducing high-velocity water into the filter basket (106) to induce whirlpool turbulence (113) as shown in FIG. 5, water pump (104) in fluid communication between the storage vessel (101) and the nozzle (107) to drive circulation as shown in FIG. 8, chilling system (110) for direct food safe water contact chilling, and an air pump (105) for pressurization.

In certain embodiments, the filter basket (106) can be removable and constructed of stainless-steel mesh, plastic, or bonded paper.

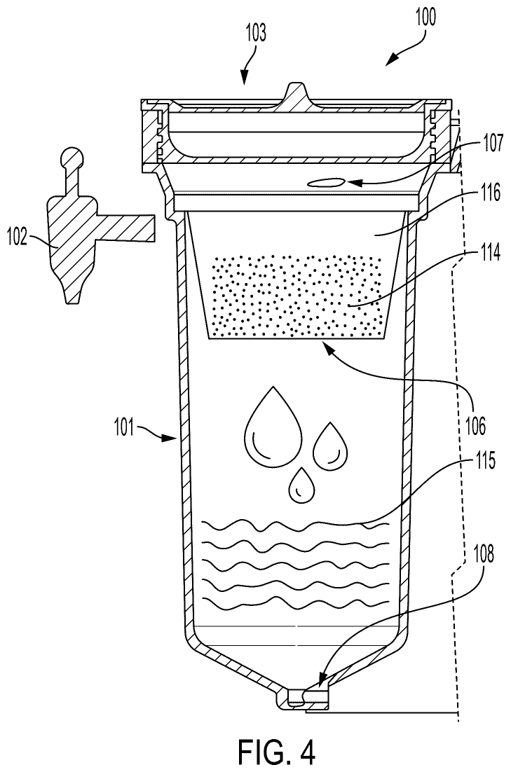

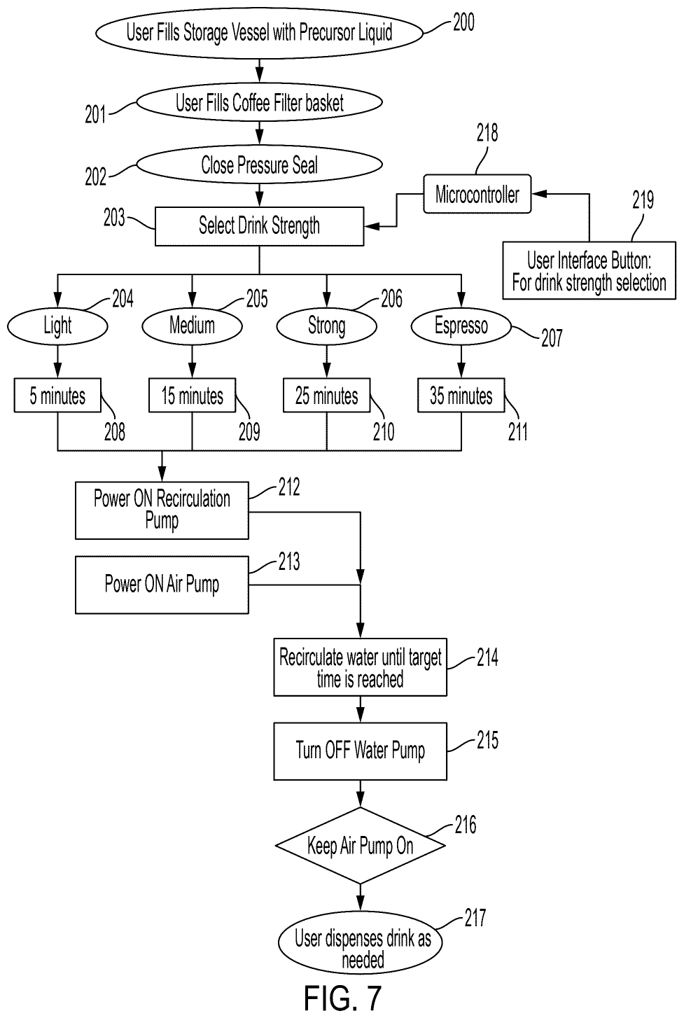

FIG. 4 illustrates a cutaway side view of the beverage vessel (101) containing hardware components filter basket (106) and pressure seal (103). The mechanism of mode one to rapidly brew cold brew beverages involves the user filling the beverage vessel with a measured volume of precursor beverage water (115), inserting and filling the filter basket (106) with a measured mass of brewable mixture (114), such as coffee grounds or tea leaves, and then closing off the pressure seal (103). In some embodiments, filling the filter basket (106) with a measured mass of brewable mixture (114) comprises using a pre-measured pod or sachet of brewable mixture (114). The water pump (104) of FIG. 3 pulls the beverage water (115) through the recirculation loop (111) of FIG. 7 comprising the fluidly interconnected internal components, and out the water jet nozzle (107) as a high-velocity liquid water jet (109) as shown in FIG. 5.

FIG. 5 illustrates a top-down view of the beverage storage vessel (101), which is filled with beverage water (115), has the filter basket (106) installed, and has the filter basket (106) filled with brewable mixture (114). The water pump (104) of FIG. 3 pulls the beverage water (115) through the recirculation loop (111) of FIG. 7, and out the water jet nozzle (107) as a high-velocity liquid water jet (109). The angle of the water jet nozzle (107) in relation to the circumference of the filter basket (106) causes a turbulent whirlpool vortex (113) which encapsulates every individual component of the brewable mixture (e.g. coffee grounds or tea leaves) (106) in beverage water (115) which is now flowing in a circular pattern around and out the bottom of the filter basket (106) and back into the Beverage Storage Vessel (101).

This varies significantly from traditional cold brew methods that have no beverage water recirculation; the brewable mixture (114) is stagnant and compacted by gravity and water pressure, or in some cases, compacted by negative vacuum pressure. It can be considered analogous to the difference between ice and liquid water. Ice is dense and compact, with unmoving individual molecules that are bonded into a solid state. Liquid water is in constant movement with each molecule in a state of vibrational excitement. The same can be said of the encompassed method of cold brew extraction. Traditional methods have a dense and compact mass of stagnant brewable mixture (114), such as coffee grounds or tea leaves, forced together by gravity into a containment bag or packet. The encompassing unique method for precise cold brew extraction is turbulent in that the water jet nozzle (107) causes a turbulent whirlpool vortex (113), which encapsulates every individual component of the brewable mixture (114) (114) in an ever-moving volume of beverage water (115).

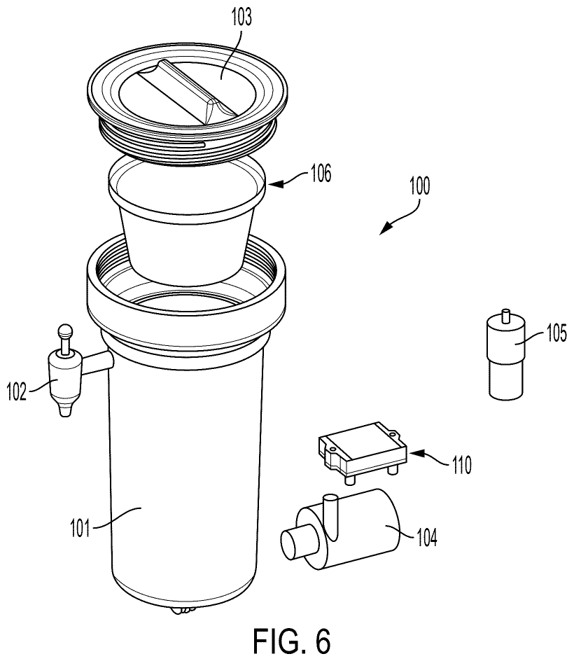

FIG. 6, displays an isotropic explosion view of the internal component layout of the beverage storage vessel (101), pressure seal (103), filter basket (106) for holding brewable mixture (114), water jet nozzle (107) for introducing turbulent whirlpool vortex (113), water pump (104) to drive recirculation, chilling system (110) for direct water contact chilling, and an air pump (105) for pressurization. These figures illustrate the modular placement of all internal systems. Here, the fluid interconnectivity of the components has been omitted.

FIG. 7 illustrates a representative process flow diagram (200-217) outlining the operational sequence for preparing a cold brew beverage using the described cold brew beverage system (100).

The process begins at step (200), where the internal volume of the beverage storage vessel is filled with precursor liquid water. The user then fills the filter basket (106) with a brewable mixture (114) such as ground coffee or other soluble beverage particulates (201). Once filled, the user closes the lidded pressure seal (202), forming a closed environment within the beverage storage vessel(101). At (203), the system prompts the user to select a desired drink strength from among several programmable profiles.

As shown in steps 204-207, the system supports multiple strength modes:
Light Strength (204): A light brew with a very short target time of 5 minutes (208).
Medium Strength (205): A medium brew with a short target time of 15 minutes (209).
Strong Strength (206): A strong brew with a long target time of 25 minutes (210).
Espresso Mode (207): A very strong brew with a very long duration time of 35 minutes (211), producing a cold-extracted espresso-like intensity.

Each target time is arbitrarily used as an example for illustration and is not indicative of real-world values. They may be shortened or lengthened to any time value. An electronic microcontroller (218) in electrical communication with the water pump (104), air pump (105), as well as the optional chilling system (10) or heating system (117) is programmed with the algorithms necessary to control the brewing components water pump (104) and air pump (105) for circulation of liquid and pressure in the liquid vessel (101), and optional chilling system (10) or heating system (117). The hardware input to the microcontroller (218) for the selection of each brew strength, temperature setting, and dispense volume control is a user interface button (219).

Once a mode is selected with the user interface button (219), the system initiates the brewing sequence via the microcontroller (218). The water pump (104) powers on (212), beginning fluid movement from the beverage storage vessel (101), through the vessel recirculation outlet (108), through the water pump (104), and up through the water jet nozzle (107), inducing a turbulent whirlpool vortex. Beverage flow is through the brewable mixture (114) and filter basket (106) and back into the beverage storage vessel (101) is induced by the water pump (104). The air pump (105) is now activated (213) with air flowing into the headspace (116) of pressurized air for pressure-assisted rapid cold brew beverage extraction. Effective air pressures for rapid extraction ranges between 2 psi and 130 psi, depending on the desired style of cold brew, which can change with grind size.

The system enters a controlled recirculation loop of the beverage water, continuing until the brew time preset for the selected strength is achieved (214). Post brewing, the water pump is turned off (215) and the air pump remains on (216) to facilitate beverage dispense or delivery on demand (217) via the dispense valve (102).

This fully automated beverage system (100) offers the user customizable strength and immediate cold dispense without manual intervention. The modular timing and pump sequencing are fully programmable through the system's user interface. Beverage dispense is activated manually on-demand by the user.

FIG. 8 through FIG. 10 depict different embodiments for the interconnectivity of the components and flow path of fluid through the system (100), resulting in the cold brewing and dispensing of the cold-brewed beverage.

FIG. 8 depicts one embodiment of the cold brew extraction process by flowing liquid from the base of the beverage storage vessel (101) powered through the water pump (104), forced out the water jet nozzle (107) and increasing its velocity, then angled at the grounds in the filter basket (106), and then enters a recirculation loop (111). The mass flow rate of the volume of the precursor liquid is determined by the water pump (104). The number of times the full volume of beverage water is recirculated is determined by the water flow rate and time interval of the water pump (104). The air pump(105) pressurizes the beverage storage vessel, creating a headspace (116) as an aid in rapidly extracting the cold brew. No thermal regulation is used in this configuration. It is brewed at ambient temperature. When ready, the user will manually open the dispense valve (102), aided by the air pump (105) and water pump (104), the cold brew beverage will flow into the drinking cup (120).

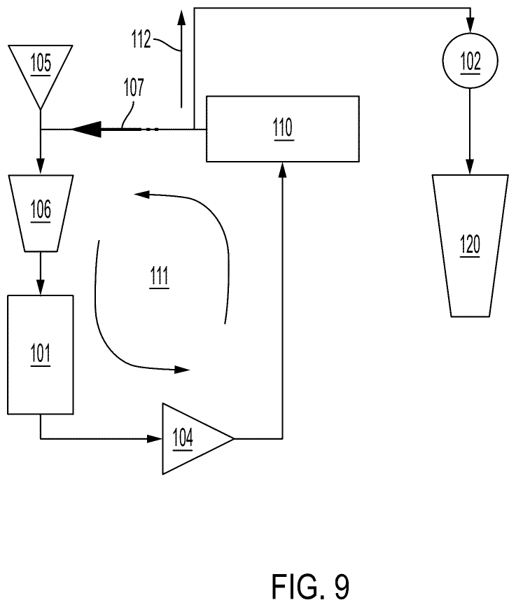

FIG. 9 depicts a second embodiment of the cold brew extraction process and builds on FIG. 8 by incorporating the chilling system (110) fluidly inline between the water pump (104) and water jet nozzle (107). Recirculated beverage water is chilled in real time during each recirculation loop (111) pass. The chilling system (110) directly allows for thermal heat transfer away from the beverage. A controller module monitors recirculation temperature until the target chilling temperature or brew time is met, and in addition, prevents the formation of ice, which can be damaging to the components.

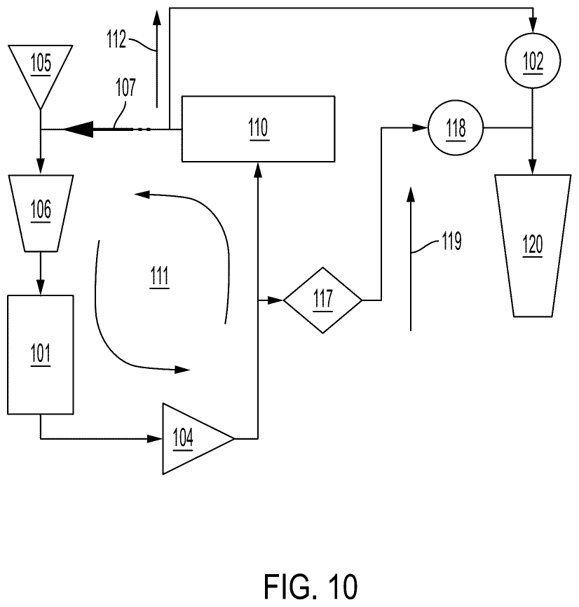

FIG. 10 depicts a third embodiment and introduces a final heating stage post-chill of the cold brew extraction process. The chilled beverage is directed through the heating system (117) just before reaching a dedicated hot dispense valve (118) downstream of the heating system (117). A selector module toggles output based on user preference. If heat is selected, the cold brew beverage will enter the heating system (117) at a cold temperature, and then exit the heating system (117) at a hot temperature. This allows either cold or hot beverage output from the same brew cycle. Both the dispense valve (102) and hot dispense valve (118) are electronically controlled.

All embodiments utilize closed-loop fluid recirculation, whirlpool flow for vortex induction, a pressurized beverage storage vessel, and optional thermal control. Control can be manual or microcontroller-driven with firmware routines.

Unlike conventional systems, this present invention achieves cold brew in minutes rather than hours, consolidating brewing, strength, and temperature functions in a single compact unit. Commercial industrial systems that brew in large batches will combine coffee grinds, water, and preservatives into a large tank at room temperature, ambient pressure (i.e., 0 psi or 1 atm), and let it sit for upwards of 8 hours to achieve cold brew coffee. Homebrew solutions, i.e., people who construct their own brewing equipment using items not designed for brewing, such as bottles, pitchers, or socks as filters, generally brew at refrigerator temperatures, ambient pressure, and let it steep for upwards of 48 hours. Known small batch consumer solutions use a pitcher, filter, and consumer-provided coffee grinds and water, which are then brewed at room temperature with negative pressure created with a small vacuum pump, and can create cold brew beverages in 30 minutes. These consumer devices lack accuracy, elevated pressures strength control, and temperature control.

The above description has been provided to convey an understanding of the features and operation of illustrative embodiments of the invention. Specific terminology has been used for clarity, but it should be understood that such terminology is not intended to limit the scope of the invention.

One skilled in the art will recognize that the described structures, control methods, and component arrangements may be altered or substituted with functionally equivalent alternatives without departing from the spirit of the invention. For example, while certain flow configurations, material choices, or user interface elements have been described, these may be adapted, replaced, or omitted in other embodiments.

Accordingly, the embodiments disclosed herein are not exhaustive and do not restrict the invention to the exact forms or components shown. Variations, enhancements, or combinations of the described features—whether now known or hereafter developed—are contemplated as within the scope of the invention.

All such modifications, equivalents, and alternative configurations that fall within the scope of the appended claims are intended to be covered by this application.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extent or degree of an action, characteristic, property, state, structure, item, or result as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may, in some instances, depend on the specific context. However, in general, the nearness of completion will be to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification, embodiments have been described in a way that enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A cold brew beverage brewing system comprising:
a storage vessel for holding a liquid;
a filter basket disposed within or above the vessel for holding a water soluble brewable mixture;
a nozzle arranged to introduce high-velocity water into the filter basket to induce a turbulent vortex or whirlpool;
a water pump in fluid communication between the storage vessel and nozzle, configured to circulate liquid from the vessel through the brewable mixture;
an air pump configured to pressurize a headspace above the liquid in the vessel;
a dispense valve configured to deliver the brewed beverage from the vessel under pressure; and
a microcontroller in electrical communication with the water pump and air pump configured to control the circulation of liquid and pressure in liquid vessel;
wherein the system operates to extract flavor from the brewable mixture via controlled recirculation of the liquid at a designated pressure.

2. The cold brew beverage brewing system of claim 1, further comprising:
a chilling system in thermal contact with a recirculated liquid flow;
wherein the system is capable of brewing and chilling the beverage liquid in a recirculating loop before dispensing.

3. The cold brew beverage brewing system of claim 1, further comprising:
a chilling system in thermal contact with a recirculated liquid flow;
a heating system in thermal contact with a dispensing beverage flow, a dedicated dispense valve downstream of the heating system; and
a user interface button selector configured to allow user control between cold dispense and hot dispense;
wherein the system provides selectively chilled or heated brewed beverage on demand.

4. The cold brew beverage brewing system of claim 3, further comprising a user interface button for brew strength, temperature setting, and dispense volume control.

5. The cold brew beverage brewing system of claim 1, wherein the filter basket is removable and constructed of stainless steel mesh, plastic, or bonded paper.

6. The cold brew beverage brewing system of claim 1, wherein the brewable mixture comprises coffee grounds.

7. The cold brew beverage brewing system of claim 1, where the brewable mixture comprises tea leaves.

8. The cold brew beverage brewing system of claim 1, where the brewable mixture comprises a pre-measured pod or sachet of brewable mixture.

9. The cold brew beverage system of claim 1, where the designated pressure is between 2 psi and 130 psi.

10. A method of brewing a cold brew beverage, the method comprising:
providing a cold brew beverage brewing system comprising:
a storage vessel for holding a liquid;
a filter basket disposed within or above the vessel for holding a water soluble brewable mixture;
a nozzle arranged to introduce high-velocity water into the filter basket to induce a turbulent vortex or whirlpool;
a water pump in fluid communication between the storage vessel and nozzle, configured to circulate liquid from the vessel through the brewable mixture;
an air pump configured to pressurize a headspace above the liquid in the vessel;
a dispense valve configured to deliver the brewed beverage from the vessel under pressure; and
a microcontroller in electrical communication with the water pump and air pump configured to control the circulation of liquid and pressure in liquid vessel;
wherein the system operates to extract flavor from the brewable mixture via controlled recirculation of the liquid at a designated pressure;
filling the storage vessel with a precursor liquid;
filling the filter basket with a brewable mixture;
sealing the storage vessel forming a closed environment within the beverage storage vessel;
initiating a microprocessor controlled brewing sequence, the brewing sequence comprising:
powering on the water pump to begin fluid movement from the beverage storage vessel, through the water pump, and up through the water jet nozzle inducing a turbulent whirlpool or vortex in the vessel wherein beverage flow is through the brewable mixture and filter basket and back into the beverage storage vessel;
activating the air pump to create a headspace of pressurized air at a desired pressure;
entering a controlled recirculation loop until a desired cold brew beverage is achieved;
turning off water pump; and
dispensing the desired cold brewed beverage from the dispense valve.

11. The method of claim 10, further comprising:
receiving an indication of a desired cold-brew beverage via a user interface button.

12. The method of claim 11, wherein the interface button allows for the selection of: brew strength, temperature setting, and dispense volume.

13. The method of claim 10, further comprising:
chilling the desired cold-brewed beverage using a chilling system in thermal contact with a recirculated liquid flow.

14. The method of claim 10, further comprising:
heating the desired cold-brew beverage using a heating system in thermal contact with a dispensing beverage flow.

15. The method of claim 14, further comprising:
dispensing a heated cold-brewed beverage from a dedicated dispense valve downstream of the heating system.

16. The method of claim 10, wherein the desired pressure is between 2 psi and 130 psi.

17. The method of claim 10, wherein the filter basket is removable and constructed of stainless steel mesh, plastic, or bonded paper.

18. The method of claim 10, wherein the brewable mixture comprises coffee grounds.

19. The method of claim 10, where the brewable mixture comprises tea leaves.

20. The method of claim 10, where the brewable mixture comprises a pre-measured pod or sachet of brewable mixture.
